(19) United States
(12) Patent Application Publication
(10) Pub. No.: US 2013/0249822 A1
(43) Pub. Date: Sep. 26, 2013

(54) ELECTRONIC DEVICE AND METHOD FOR TRANSMITTING FILES USING THE SAME

(71) Applicant: CHENG-PING DAI, Shenzhen City (CN)

(72) Inventor: CHENG-PING DAI, Shenzhen City (CN)

(21) Appl. No.: 13/650,110

(22) Filed: Oct. 11, 2012

(30) Foreign Application Priority Data
Mar. 23, 2012 (CN) 201210079362.5

(51) Int. Cl. G06F 3/041

(52) U.S. Cl. 345/173

(57) ABSTRACT

In a method of transmitting a file of an electronic device, the electronic device sets one or more borderlines of a touch screen, and generates a search signal to search a recipient electronic device to receive the file when the file has been dragged outside of one of the borderlines. Upon the electronic device is in electronic connection with the recipient electronic device, the electronic device sends the file to the recipient electronic device

### BACKGROUND

1. Technical Field

Embodiments of the present disclosure relate to communication technology, and more particularly to an electronic device and a method for transmitting files using the electronic device.

2. Description of Related Art

People who use an electronic device (e.g., a mobile phone) may want to exchange data with other electronic devices via a wireless network (e.g., BLUETOOTH). For example, when a user views a file using a first electronic device, and wants to share the file with a friend who has a second electronic device, a connection between the first and second electronic devices needs to be established first, then the file in the first electronic device is chosen and transmitted to the second electronic device. Thus, it is inconvenient for the file to be shared with other people. Therefore, what is needed is an electronic device and a transmission method to overcome the aforementioned problem.

### BRIEF DESCRIPTION OF THE DRAWINGS

FIG. 1 is a block diagram of one embodiment of a first electronic device and a second electronic device including a transmitting system.

FIG. 2 is a block diagram of function modules of the transmitting system included in the first and second electronic devices of FIG. 1.

FIG. 3 is a flowchart of one embodiment of a transmitting method to transmit a file from the first electronic device of FIG. 1.

FIG. 4 is a flowchart of one embodiment of a transmitting method to receive a file by the second electronic device of FIG. 1.

FIG. 5 is a schematic diagram of one embodiment of setting borderlines of a touch screen of the first electronic device of FIG. 1.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

In general, the word module, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, BLU-RAY, flash memory, and hard disk drives.

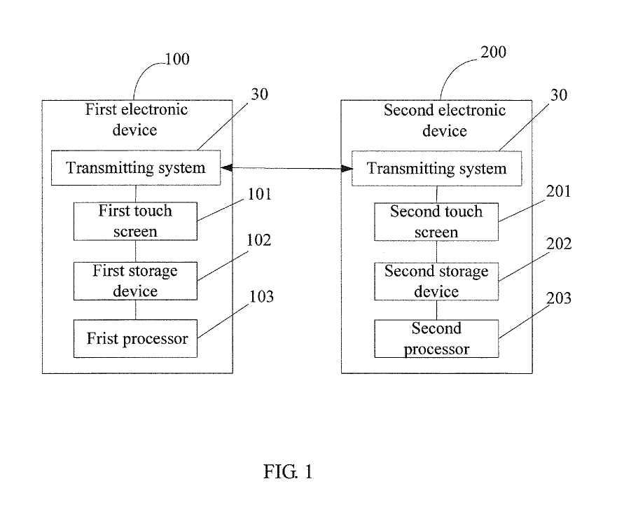

FIG. 1 is a block diagram of one embodiment of a first electronic device 100 in communication with a second electronic device 200. The first electronic device 100 and the second electronic device 200 may be mobile phones, personal digital assistants (PDAs), tablet computers, or other computing devices.

The first electronic device 100 includes a first touch screen 101, a first storage device 102, and a first processor 103. The second electronic device 200 includes a second touch screen 201, a second storage device 202, and a second processor 203. The first touch screen 101 and the second touch screen 201 may be touch panels, which support multi-touch, such as resistive touch screens or capacitive touch screens.

The first storage device 102 and the second storage device 202 may be used to store various data, such as files, images, videos, for example.

In some embodiments, both of the first electronic device 100 and the second electronic device 200 include a transmitting system 30. The transmitting system 30 transmits specified data between the first electronic device 100 and the second electronic device 200. Further details will be provided below.

The first electronic device 100 and the second electronic device 200 are generally controlled and coordinated by an operating system, such as UNIX, LINUX, WINDOWS, MAC OS X, ANDROID, SYMBIAN, an embedded operating system, or any other compatible operating systems. In other embodiments, the first electronic device 100 and the second electronic device 200 may be controlled by proprietary operating systems. All such operating systems control and schedule computer processes for execution, perform memory management, provide a file system, networking, and I/O services, and provide a user interface, such as a graphical user interface (GUI), among other things.

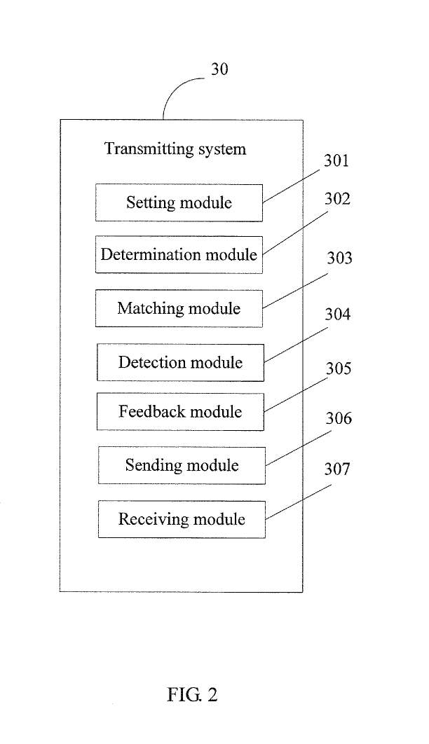

FIG. 2 is a block diagram of function modules of the transmitting system 30 included in the first electronic device 100 and the second electronic device 200 of FIG. 1. In one embodiment, the transmitting system 30 may include a setting module 301, a determination module 302, a matching module 303, a detection module 304, a feedback module 305, a sending module 306, and a receiving module 307. The modules 301-307 comprise computerized codes in the form of one or more programs that may be stored in each of the first storage device 102 and the second storage device 202. The computerized code includes instructions that are executed by the first processor 103 or by the second processor 203 to provide functions for the modules.

In some embodiments, the first electronic device 100 may be a sender electronic device to transmit files to the second electronic device 200, and the second electronic device 200 may be a recipient electronic device to receive the files from the first electronic device 100. In other embodiments, the first electronic device 100 may be the recipient electronic device, and the second electronic device 200 may be the sender electronic device.

For simplicity in describing the transmitting system 30 below, the first electronic device 100 is considered as the sender electronic device and the electronic device 200 is considered as the recipient electronic device.

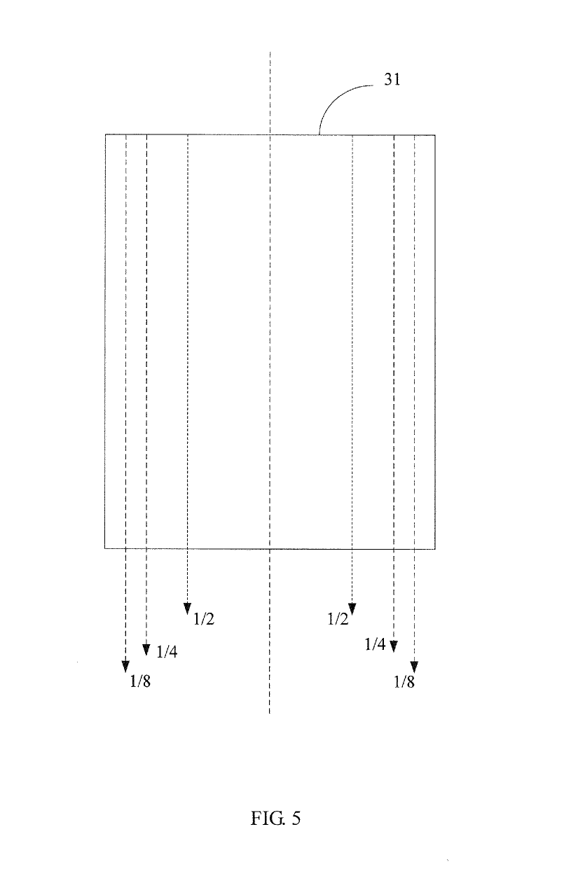

The word “borderlines” is defined to be one or more imaginary lines that limits a border of the first touch screen 101 of the first electronic device 100. For example, as shown in FIG. 5, lines indicating ⅛ or ¼ or ½ of half of a width of the first touch screen 101, may be set as the borderlines. The setting module 301 sets one or more borderlines of the first touch screen 101 of the first electronic device 100. In one embodiment, the setting module 301 sets the lines that indicate ¼ of half of the width of the first touch screen 101 as the borderlines.

The determination module 302 determines whether a file of the first electronic device 100 has been dragged outside of one of the borderlines. For example, if a user uses a mouse of the first electronic device 100 to drag and drop the file outside of one of the borderlines, the determination module 302 determines that the file needs to be shared with other electronic devices.

The matching module 303 generates a search signal to search one or more electronic devices that agree to receive the file when the file has been dragged outside of one of the borderlines. In one embodiment, the search signal may be a handshake signal or another kind of connection signal. The electronic devices that agree to receive the file will be considered as the recipient electronic devices. For simplification, it is assumed that the second electronic device 200 is the recipient electronic device that agrees to receive the file.

The determination module 302 further determines whether the first electronic device 100 receives a response signal from the recipient electronic device (e.g. the second electronic device 200), the response signal represents that the recipient electronic device agrees to receive the file.

The matching module 303 further establishes an electronic connection, such as a BLUETOOTH connection, between the first electronic device 100 and the recipient electronic device (e.g. the second electronic device 200) when the first electronic device 100 receives the response signal from the recipient electronic device.

The sending module 306 sends the file to the recipient electronic device (e.g. the second electronic device 200) when the first electronic device 100 is in electronic connection with the recipient electronic device, via a wireless network such as the BLUETOOTH.

The detection module 304 in the recipient electronic device (e.g. the second electronic device 200) detects the search signal from the first electronic device 100, and further detects a trigger signal to receive the file in response to the search signal. In one embodiment, the trigger signal is created in response to a touch/click/press operation on an icon displayed on the second touch screen 201 of the second electronic device 200. The icon may be a circular icon, a triangular icon or, a rectangular icon. In one embodiment, the icon is a circular icon.

The feedback module 305 in the recipient electronic device (e.g. the second electronic device 200) sends a response signal to the first electronic device 100 to agree to receive the file in response to the trigger signal.

The receiving module 306 in the recipient electronic device (e.g. the second electronic device 200) receives the file from the first electronic device 100 when the first electronic device 100 is in electronic connection with the recipient electronic device.

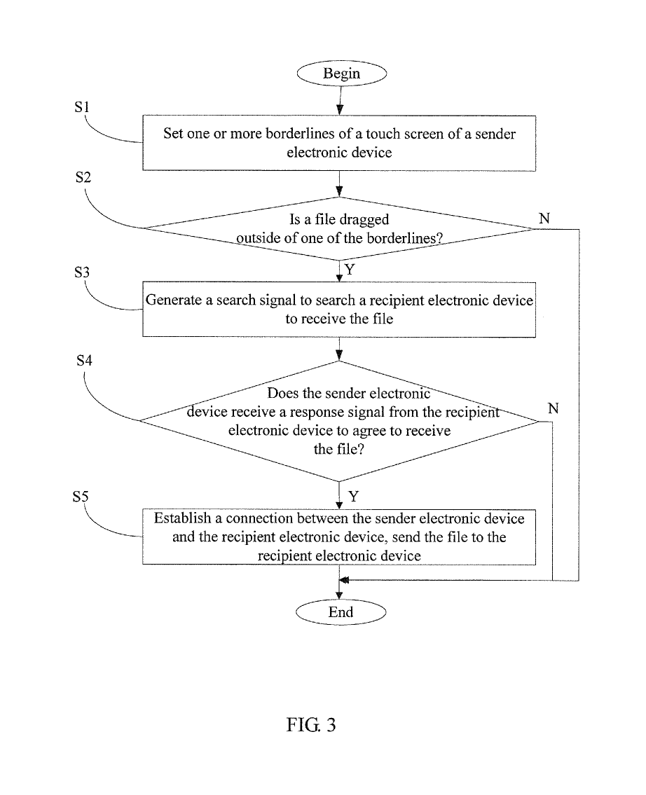

FIG. 3 is a flowchart of one embodiment of a transmitting method to transmit a file from the first electronic device 100 of FIG. 1. Depending on the embodiment, additional blocks may be added, others deleted, and the ordering of the blocks may be changed.

In step S1, the setting module 301 sets one or more imaginary lines that limit a border of the first touch screen 101 of the first electronic device 100. For example, as shown in FIG. 5, lines indicating ⅛ or ¼ or ½ of half of a width of the first touch screen 101 may be set as the borderlines. In one embodiment, the setting module 301 sets the lines, which indicate ¼ of half of the width of the first touch screen 101 as the borderlines.

In step S2, the determination module 302 determines whether a file has been dragged outside of one of the borderlines. For example, if a user uses a mouse of the first electronic device 100 to drag and drop the file outside of one of the borderlines, the determination module 302 determines that the file needs to be shared with other electronic devices. If the file is determined to be shared with other electronic devices, step S3 implemented, otherwise if the file is not determined to be shared with other electronic devices, the process ends.

In step S3, the matching module 303 generates a search signal to search one or more electronic devices that agree to receive the file when the file has been dragged outside of one of the borderlines. In one embodiment, the search signal may be a handshake signal or another kind of connection signal. The electronic devices that agree to receive the file will be considered as the recipient electronic devices. For simplification, it is assumed that the second electronic device 200 is the recipient electronic device that agrees to receive the file.

In step S4, the determination module 302 further determines whether the first electronic device 100 receives a response signal from the recipient electronic device (e.g. the second electronic device 200), the response signal represents that the recipient electronic device agrees to receive the file. In one embodiment, the determination module 302 determines whether the first electronic device 100 receives the response signal in a predetermined time period (e.g. 30 seconds). If the first electronic device 100 receives the response signal in the predetermined time period, step S5 is implemented, otherwise, the process ends.

In step S5, the matching module 303 further establishes an electronic connection, such as a BLUETOOTH connection, between the first electronic device 100 and the recipient electronic device (e.g. the second electronic device 200) when the first electronic device 100 receives the response signal from the recipient electronic device. The sending module 306 sends the file to the recipient electronic device (e.g. the second electronic device 200) via a wireless network such as the BLUETOOTH.

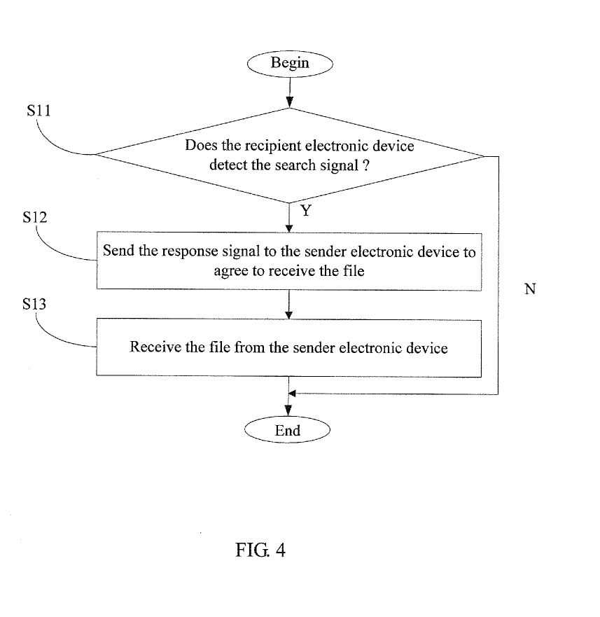

FIG. 4 is a flowchart of one embodiment of a transmitting method to receive a file by the second electronic device 200 of FIG. 1. Depending on the embodiment, additional blocks may be added, others deleted, and the ordering of the blocks may be changed.

In step S11, the detection module 304 in the recipient electronic device (e.g. the second electronic device 200) detects the search signal from the first electronic device 100, and further detects a trigger signal to receive the file in response to the search signal. In one embodiment, the trigger signal is created in response to a touch/click/press operation on an icon displayed on the second touch screen 201 of the second electronic device 200. The icon may be a circular icon, a triangular icon or, a rectangular icon. In one embodiment, the icon is a circular icon.

In step S12, the feedback module 305 in the recipient electronic device (e.g. the second electronic device 200) sends a response signal to the first electronic device 100 to agree to receive the file in response to the trigger signal.

In step S13, the receiving module 306 in the recipient electronic device (e.g. the second electronic device 200) receives the file from the first electronic device 100 when the first electronic device 100 is in electronic connection with the recipient electronic device (e.g. the second electronic device 200).

Although embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device, comprising:
a touch screen;
a storage device;
at least one processor; and
one or more programs that are stored in the storage device and are executed by the at least one processor, the one or more programs comprising:
a setting module that sets one or more borderlines, the borderlines being one or more imaginary lines that limit a border of the touch screen of the electronic device;
a determination module that determines whether a file is dragged outside of one of the borderlines;
a matching module that searches for a recipient electronic device to receive the file when the file has been dragged outside of one of the borderlines, the searching according to sending a search signal to the recipient electronic device;
the determination module further determining whether the recipient electronic device agrees to receive the file by receipt of a response signal from the recipient electronic device;
the matching module further establishing an electronic connection between the electronic device and the recipient electronic device when the response signal from the recipient electronic device is received; and
a sending module that sends the file to the recipient electronic device.

2. The electronic device of claim 1, wherein the determination module further determines whether the response signal is received within a predetermined time period after the electronic device generates the search signal.

3. A method of transmitting files of an electronic device, the electronic device comprising a touch screen, a storage device, and at least one processor, the method comprising:
setting one or more borderlines, the borderlines being one or more imaginary lines that limit a border of the touch screen of the electronic device;
determining whether a file is dragged outside of one of the borderlines;
searching for a recipient electronic device to receive the file when the file has been dragged outside of one of the borderlines, the searching according to sending a search signal to the recipient electronic device;
determining whether the recipient electronic device agrees to receive the file by receipt of a response signal from the recipient electronic device;
establishing an electronic connection between the electronic device and the recipient electronic device when the response signal from the recipient electronic device is received; and
sending the file to the recipient electronic device.

4. The method according to claim 3, further comprising:
determining whether the response signal is received within a predetermined time period after the electronic device generates the search signal.

5. A non-transitory storage medium having stored thereon instructions that, when executed by a processor of an electronic device, causes the electronic device to perform a method of transmitting files of the electronic device, the method comprising:
setting one or more borderlines, the borderlines being one or more imaginary lines that limit a border of the touch screen of the electronic device;
determining whether a file is dragged outside of one of the borderlines;
searching for a recipient electronic device to receive the file when the file has been dragged outside of one of the borderlines, the searching according to sending a search signal to the recipient electronic device;
determining whether the recipient electronic device agrees to receive the file by receipt of a response signal from the recipient electronic device;
establishing an electronic connection between the electronic device and the recipient electronic device when the response signal from the recipient electronic device is received; and
sending the file to the recipient electronic device.

6. The non-transitory storage medium according to claim 5, further comprising:
determining whether the response signal is received within a predetermined time period after the electronic device generates the search signal.
